(19) United States
(12) Patent Application Publication
(10) Pub. No.: US 2007/0091812 A1
(43) Pub. Date: Apr. 26, 2007

(54) Communication system and method utilizing a satellite network

(75) Inventors: Nikhil Marathe, Chicago, IL (US); Shadi Khoshaba, Skokie, IL (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/257,232

(22) Filed: Oct. 24, 2005

(51) Int. Cl. H04J 3/14

(52) U.S. Cl. 370/242; 370/248

(57) ABSTRACT

The invention describes a system and method of providing a telecommunication, typically using Signaling System 7 (SS7) protocol, in which data is transferred over a standard communication link (i.e., hardwire, optical fiber) between a first and a second telecommunication device in a telecommunication network, and a communication link is established over a satellite, such as a Low Earth Orbiting (LEO) satellite, in order to transfer the data between the first and second telecommunication devices when the data transfer over the standard communication link is impaired. Signals are generally converted from a first format to a second format that is suitable for satellite transmission. The first device is typically a Service Switching Point (SSP) and the second device is typically a Signal Transfer Point (STP). The communication link over a satellite is automatically established in response to detecting a failure in the standard communication link.

### BACKGROUND OF THE INVENTION

1. Field of the Invention

The present invention relates to the field of communication network maintenance. In particular, the present invention discusses a system and method for providing a backup to a standard link of a Signaling System 7 network using Low Earth Orbiting satellites.

2. Description of the Related Art

In any telephone system, some form of signaling mechanism is used to manage calls, i.e. setup calls, tear down calls, etc. Some general functions of a signaling system include supervising a line or circuit (monitoring the status of a line or circuit to see if it is busy, idle, or requesting service), alerting a user to indicate arrival of an incoming call, and addressing a call (transmitting routing and destination signals over the network, using dial pulses, for example, to deliver a telephonic signal to its destination). Signaling System 7 (SS7) is a signaling system that employs a 64 kilobit data circuit to carry packetized machine language messages about a call between machines of a network.

SS7 operates over a network, separate from a voice network and from the Public Switched Telephone Network (PSTN), to route telephone calls and provide call management. The SS7 network also carries other telephone company services, such as Advanced Intelligent Network (AIN) and Local Number Portability (LNP) services. Some exemplary uses of the SS7 network and protocol include providing for call management and providing enhanced call features, such as call forwarding, call waiting, call screening, call transfer, etc., to a full international network.

An SS7 network generally includes a Service Switching Point (SSP), a Signal Transfer Point (STP), and a Service Control Point (SCP). An SCP is a local database used for determining how a call is handled. The SCP has the ability, for example, to screen ten digits of an 800 number and route calls to the appropriate customer-designated long distance carrier. An SSP is the local exchange of a telephone network. An SSP may be a combination of a voice switch for transferring voice signals and an SS7 switch for transferring call management signals, or may be an adjunct computer connected to the voice switch of the local exchange. The SSP communicates with the voice switch and creates packets for transmission over the SS7 network. The SSP routes and connects the signals under the direction of an SCP. An SSP generally resides at an end office. An end office is a central office to which a telephone subscriber is connected and delivers a dial tone to the subscriber. An STP serves as a router in the SS7 network for transferring signaling messages from one link to another. In normal operation, the first local STP identifies a unique code of the call that identifies an SS7 node in order that an SS7 network may route calls properly. This unique code is known as a point code. A destination point code is identified by, for example, looking up a caller identification (caller ID) or Internet Protocol (IP) address of the receiving caller. Often, an SSP creates a query to find out how a call should be handled. The query is passed through STPs to an SCP that interprets the query based on the criteria in its database and information provided by the SSP. Once the SCP has determined how the call is to be handled, it returns a message through STPs to the SSP. This message instructs the SSP how the call should be handled in the network.

FIG. 1 (Prior Art) illustrates an exemplary SS7 network for providing a call management functions. An SSP 102 converts between signals from a voice switch, such as phone 104, and signals transmittable over the SS7 network. STPs 108 and STPs 109 are provided to route SS7 signals throughout the SS7 network. The STPs are typically deployed in mated STP pairs. For example, STPs 108 form a mated STP pair, and STPs 109 form a mated STP pair. An SCP 110 provides a database that may be queried to determine how a call should be handled. The SS7 network elements (i.e., SSPs, STPs, SCPs) are interconnected over standard links, such as fiber optic links, copper cable links, or any other standard links commonly used in the industry.

Typically, SSPs within the SS7 network connects to STPs via multiple (i.e. 2 to 4) standard links that are diversely routed to ensure that local impacts do not cause all communications paths to fail at the same time. Access links (“A” links) 115 connect an SSP 102 to nearby STPs 108. Messages originating from or destined to the signaling end point are commonly transmitted over the “A” link. Extended links (“E” links) 117 connect an SSP to alternate STPs 109, generally STP that are physically remote from the SSP. “E” links provide an alternate signaling path if a “local” STP (i.e., STP 108) cannot be reached via an “A” link. “E” links provide increased resilience and load sharing to the SS7 network. “E” links are not usually provided unless the benefit of a marginally higher degree of reliability justifies the added expense.

Despite the diverse routing of the multiple links discussed above, there may be locations where these links are transported over the same transport facilities. If that single transport facility fails, the standard link becomes inoperative or experiences an outage. The industry as a whole reports anywhere from 50-70 outages within the SS7 network each year. Any outage that lasts a significant amount of time (i.e., 5 seconds or more) may result in costly fines. Thus, the telecommunications industry recognizes the importance of maintaining the integrity of Signaling System 7 (SS7) networks by providing a backup link to the standard links of the SS7 network.

### SUMMARY OF THE INVENTION

The invention describes a method of providing a telecommunication, in which data is transferred over a standard communication link between a first and a second telecommunication device in a telecommunication network, and a communication link is established over a satellite in order to transfer the data between the first and second telecommunication devices when the data transfer over the standard communication link is impaired. In one embodiment of the invention, establishing the communication link over a satellite further includes establishing a communication link over a Low Earth Orbiting (LEO) satellite. Transferring data typically refers to utilizing a Signaling System 7 protocol. The first device is typically a Service Switching Point (SSP) and the second device is typically a Signal Transfer Point (STP). The standard communication link may include a hardwire, or an optical link. Establishing the communication link over a satellite includes detecting a failure in the standard communication link and automatically establishing the communication link over a satellite in response to detecting the failure in the standard communication link. Signals are typically converted so that signals provided by the first telecommunication device in a first format may be sent in a second format for transmission over the satellite.

The invention also describes a telecommunication system, including a standard communication link for transferring data between a first and a second telecommunication device in a telecommunication network, and a communication link over a satellite established for transferring the data between the first and second telecommunication devices when the data transfer over the standard communication link is impaired. In the system, the communication link over a satellite may be a communication link over a LEO satellite. The first device is typically a Service Switching Point (SSP) and the second device is a Signal Transfer Point (STP). The standard link may include a hardwire link or an optical link. The communication link is established over the satellite by detecting a failure in the standard communication link, and automatically establishing the communication link over a satellite link in response to detecting the failure in the standard communication link. Data is typically transferred utilizing a Signaling System 7 protocol. The system also includes a mediation device for converting signals provided by the first telecommunication device in a first format to signals in a second format for transmission over the satellite. Data may be split over multiple channels, generally using the mediation device. For the purpose of this disclosure, the terms impairment or failure means that the performance of an element, such as the physical link between the SSP in the communication network is either partially or fully not performing or one or more intended functions or operations. For example, the link may be impaired if the data transfer over the link is experiencing excessive noise, or the link is physically damaged, etc.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of an exemplary embodiment, taken in conjunction with the accompanying drawings, in which like elements have been given like numerals.

FIG. 1 (Prior Art) illustrates an exemplary Signal Switching 7 (SS7) communication network for providing call management functions;

FIG. 2 illustrates an exemplary embodiment of the invention for providing a backup to a standard link of the SS7 network using a Low Earth Orbiting (LEO) satellite; and

FIGS. 3 and 4 illustrate an exemplary flowchart of a process for activating one or more LEO backup links to the SS7 network.

### DETAILED DESCRIPTION OF THE INVENTION

In view of the above, the present invention through one or more of its various aspects and/or embodiments is presented to provide one or more advantages, such as those noted below.

The invention describes a method of providing a telecommunication, in which data is transferred over a standard communication link between a first and a second telecommunication device in a telecommunication network, and a communication link is established over a satellite in order to transfer the data between the first and second telecommunication devices when the data transfer over the standard communication link is impaired. In one embodiment of the invention, establishing the communication link over a satellite further includes establishing a communication link over a Low Earth Orbiting (LEO) satellite. Transferring data typically includes utilizing a Signaling System 7 protocol. Signals provided by the first telecommunication device in a first format may be sent in a second format for transmission over the satellite. Signals may be split and transferred over multiple channels. The first device is typically a Service Switching Point (SSP) and the second device is typically a Signal Transfer Point (STP). The standard communication link may include a hardwire, or an optical link. Establishing the communication link over a satellite includes detecting a failure in the standard communication link and automatically establishing the communication link over a satellite in response to detecting the failure in the standard communication link.

The invention also describes a telecommunication system, including a standard communication link for transferring data between a first and a second telecommunication device in a telecommunication network, and a communication link over a satellite established for transferring the data between the first and second telecommunication devices when the data transfer over the standard communication link is impaired. In the system, the communication link over a satellite may be a communication link over a LEO satellite. Data is typically transferred utilizing a Signaling System 7 protocol. The first device is typically a Service Switching Point (SSP) and the second device is a Signal Transfer Point (STP). The standard link may include a hardwire link or an optical link. The communication link is established over the satellite by detecting a failure in the standard communication link, and automatically establishing the communication link over a satellite link in response to detecting the failure in the standard communication link. The system also includes a mediation device for converting signals provided by the first telecommunication device in a first format to signals in a second format for transmission over the satellite. Signals may be split over multiple channels, generally using the mediation device.

The invention provides a system for providing a backup connection to a Signaling System 7 (SS7) communication network. The invention includes at least one Service Switching Point (SSP) for converting between signals from a voice switch and an SS7 signal and at least one Signal Transfer Point (STP) for routing SS7 signals through the SS7 communication network that is connected to the at least one SSP via a standard communication link. The at least one SSP further may include a plurality of SSPs, and the at least one STP may further include a plurality of STPs. In one aspect of the invention, the at least one standard communication link may further include a plurality of standard communication links. A communication link over a Low Earth Orbiting Satellite may be activated to transfer information between the at least one SSP and the at least one STP when a failure is detected in the at least one standard communication link. The communication link over a LEO satellite further includes a mediation device for converting between a signal transmittable over the at least one standard communication link and a signal transmittable over the LEO communication link. Signals may be split and sent over multiple channels, generally using the mediation device.

The invention also provides a method of providing a backup signaling system for a Signaling System 7 (SS7) communication network over a Low Earth Orbiting satellite network. A failure is detected of at least one standard SS7 link between at least one Service Switching Point (SSP) for converting between signals from a voice switch and an SS7 signal and at least one Signal Transfer Point (STP) that routes the SS7 signal through the SS7 network. A communication link over a LEO satellite between the at least one SSP and the at least one STP is activated over a Leo Earth Orbiting satellite link. In one aspect of the invention, the at least one SSP further includes a plurality of SSPs, and the at least one STP further includes a plurality of STPs. Also, the at least one standard link may further include a plurality of standard links. The method also includes converting between a signal transmittable over the at least one standard link and a signal transmittable over the LEO communication link, and transmitting the converted signal over a LEO satellite link. Signals may be split and sent over multiple channels, generally using the mediation device.

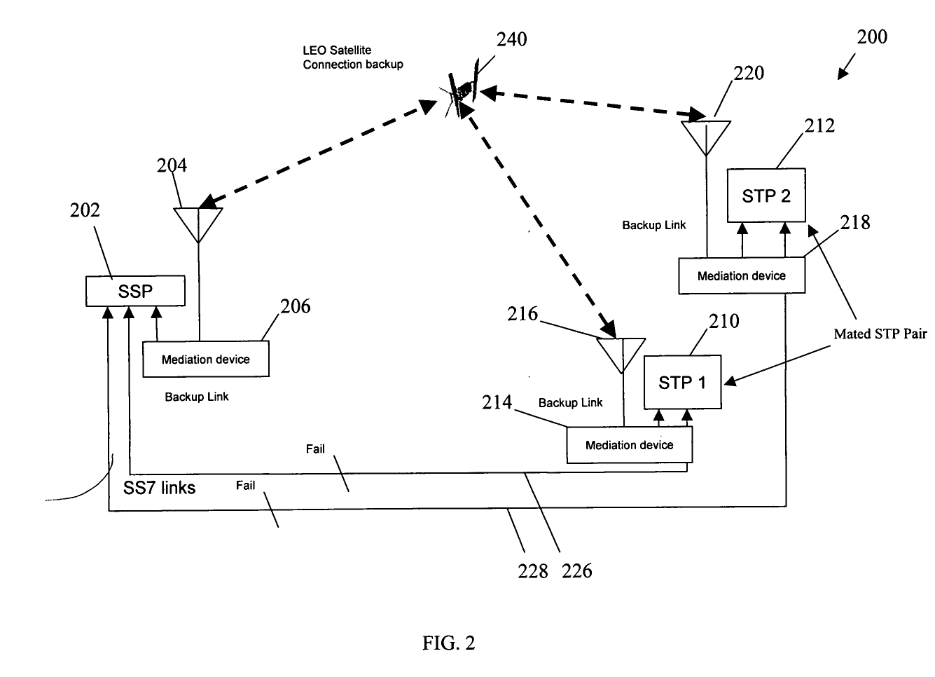

FIG. 2 illustrates an exemplary embodiment 200 of the invention for providing a backup to a standard link of an SS7 network over a link to a Low Earth Orbiting (LEO) satellite. The network includes multiple standard links and a wireless backup link to establish communication between network elements. The standard SS7 network connects at least one SSP to at least one STP over these multiple standard links. SSP Switch 202 connects to a first STP (STP1) 210 over a first standard link 226 and connects to a second STP (STP2) 212 over a second standard link 228. These standard links may be made of copper cable, fiber optic cable, or other suitable cable used in the industry. The backup channel may link an SSP to an STP using devices that communicate with a Low Earth Orbiting (LEO) satellite 240. SSP Switch 202 connects to a mediation device 206 capable of converting between a protocol for a transmitting a signal over the standard link and a protocol for a transmitting a signal over a LEO satellite link. A mediation device may be a stand-alone device or a device integrated into an associated SS7 device, such as an SSP. In one example, the mediation device 206 communicates with the LEO satellite 240 using an appropriate device, such as antenna 204, for transmitting and receiving signals to and from the LEO satellite. Similarly, STP1 210 connects to a mediation device 214 having an antenna 216 for transmitting to and receiving from the LEO satellite. Also, STP1 212 connects to mediation device 218 having antenna 220 for transmitting to and receiving from the LEO satellite 240. At least one backup link may be provided over the LEO satellite. One exemplary backup link includes switch 202, antenna 204, mediation device 206, LEO satellite 240, antenna 214, mediation device 204, and STP1 210.

The mediation device may serve to convert SS7 signals into a format and speed acceptable to the link over LEO satellites, while being transparent to the SSP/STP. Transparency refers to the ability of the mediation device to change communication links without the SS7 devices being aware of the change. The mediation device may have the ability to choose transmission speeds to accommodate the speed of the LEO link. Current SS7 links are configured to the STP they terminate in. The invention therefore configures SSPs and STPs (either prior to impairment of the standard SS7 link or at the time of impairment) so as to recognize SS7 links from different SS7 elements (i.e., SSPs and STPs). When the standard links 226 and 228 fail between the SSPs and the STPs, then the LEO backup link may be activated to reestablish a connection. The standard link may be monitored for when it become operative again, so that the signal may be switched back from the LEO backup link to the standard link. It should be noted that, for the purpose of this disclosure, the terms impairment or failure means that the performance of an element, such as the physical link between the SSP in the communication network is either partially or fully not performing or one or more intended functions or operations. For example, the link may be impaired if the data transfer over the link is experiencing excessive noise, or the link is physically damaged, etc.

The mediation device may further include a data splitter for splitting the signal into channels that may be transmitted over the LEO satellite. For example, some standard SS7 communication links currently operate at a 56 kbps capacity. A satellite link may have a 9.6 kbps capacity, which may not be enough, on its own, to handle the capacity of the standard link. By splitting the data over many channels, the SS7 signal may be carried over multiple satellite links. The mediation device receiving the signal may regroup the signal and forward it to the SS7 device, such as the SSP or the STP, associated with the receiving mediation device.

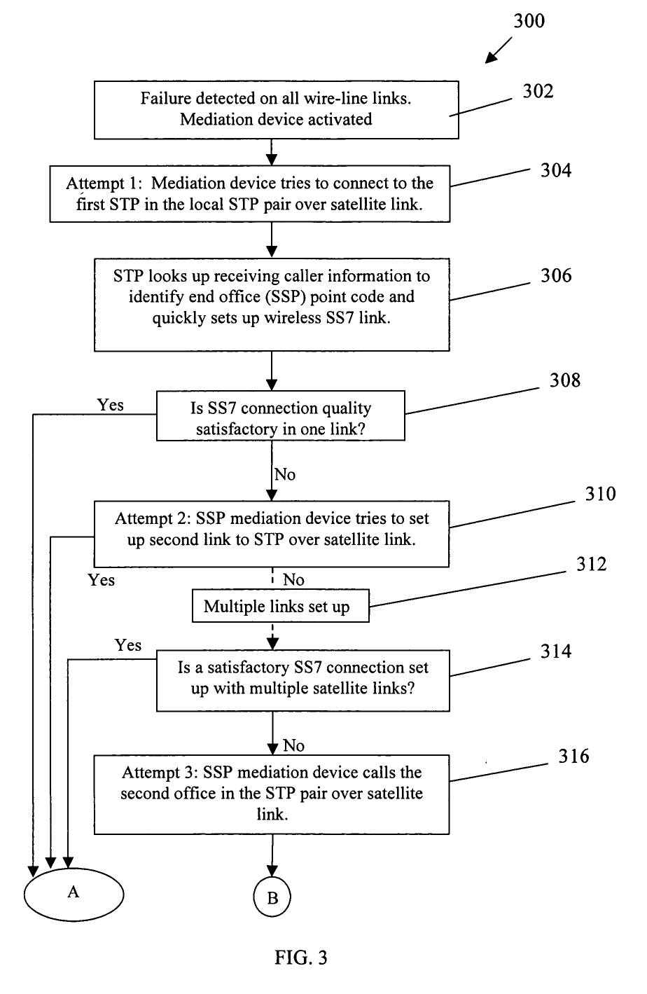

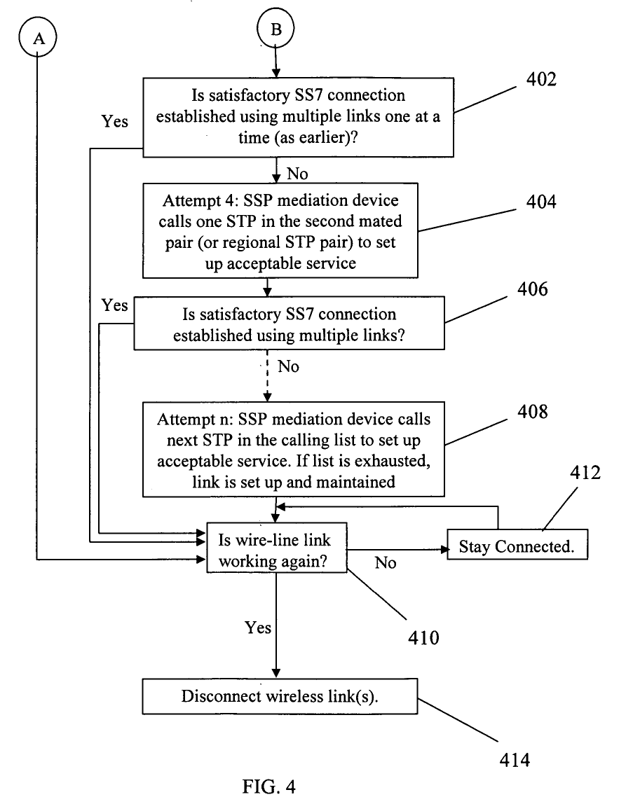

FIGS. 3 and 4 illustrate a flowchart 300 of a process for activating one or more LEO backup links to the SS7 network. The process of providing one or more LEO backup links begins when a failure is detected in the standard link (Box 302). In Box 304, an SSP in an end office calls a first local STP over a wireless link such as a link through a LEO satellite. In FIG. 2, this first local STP may be represented by STP1 210. A LEO backup link is then activated between the SSP and the first local STP (Box 306). The LEO backup link activated in Box 306 is analogous to an “A” link in the SS7 network. In Box 308, the LEO backup link activated in Box 306 is tested for quality of service issues to determine whether the link is satisfactory for transmission purposes. Some exemplary quality of service issues include low data rate, too many bit resends, noise levels, delay times, out-of-sync packet arrival, etc. These quality of service issues may occur, for instance, due to bad wireless reception or disruptive weather conditions. If the LEO backup link to the first local STP is satisfactory, the signal is transferred over the LEO backup link, and the failed standard link is monitored (Box 410). The signal may be transferred back to the standard link once the standard link returns to an operative state.

If the connection activated in Box 306 is found not to be satisfactory (i.e., fails quality of service test), a second attempt to provide a LEO backup link may be made in which the SSP calls a second STP (Box 310). A link established to a second STP may be used to replace the first link having poor link quality. Alternatively, the link to the second STP may be used alongside the first link, thereby setting up multiple links that may be used together to provide the backup link (Box 312). Subsequent link that are established as described in the flowchart of FIGS. 3 and 4 may also be used along with previously established links. Generally, the second attempt is made to the STP (i.e. STP2 212 of FIG. 2) that is mated to the first STP contacted. In Box 314, a test is made of the LEO backup link activated in Box 310 to determine whether the connection is satisfactory. In the event that the LEO backup link to the second local STP is satisfactory, the signal may be transferred over the backup link, and the failed standard link is monitored (Box 410). The signal may be transferred back to the standard link once the standard link returns to an operative state.

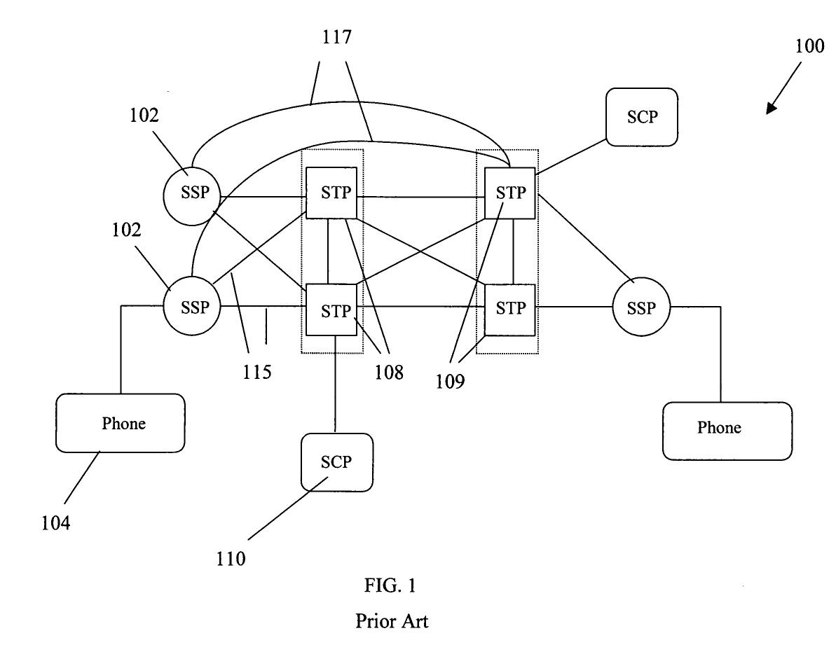

Some regions may have multiple STP pairs. If the connection activated in Box 310 is found not to be satisfactory, a third attempt to provide a LEO backup link may be made (Box 316). The third attempt is generally to a first STP in a second (regional) STP pair over a wireless link. The LEO backup link activated in Box 316 is analogous to an “E” link in the SS7 network (shown in FIG. 1). In Box 402, a test is made of the LEO backup link activated in Box 316 to determine whether the connection is satisfactory. In the event that the connection of Box 316 is satisfactory, the signal may be transferred over the LEO backup link, and the failed standard link is monitored (Box 410). The signal may be transferred back to the standard link once the standard link returns to an operative state.

If the connection activated in Box 316 is not satisfactory, a fourth attempt to provide a backup link may be made to the second STP in the second (regional) pair over the LEO backup link (Box 404). In Box 406, a test is made of the link activated in Box 404 to determine whether the connection is satisfactory. In the event that the connection of Box 404 is satisfactory, the signal may be transferred over the backup link, and the failed standard link is monitored (Box 410). The signal may be transferred back to the standard link once it returns to an operative state. In Box 408, the mediation device may continue calling more STPs to establish more backup links or may end call attempts once all STPs have been contacted.

Although the exemplary flowchart of FIGS. 3 and 4 shows four attempts at activating a backup link over LEO satellites, any number of attempts to activate a LEO backup link may be made to any number of switches until a satisfactory connection is activated. Alternatively, a link to an alternate LEO satellite may be activated if links to the first LEO satellite are unsatisfactory for signal transmission. If a LEO satellite link to a first STP is found to be unsatisfactory, and a second link is set up to the second STP in the mated pair, these two links may function by themselves or together. When testing a link, if the quality of service is satisfactory but the data rate is insufficient, multiple links may be set up to the same STP over the LEO satellite link. The LEO backup links are not always active links and are only activated in case of failure of the standard links. Once the LEO backup link is activated, routing information is updated to reflect the new configuration, links, and route.

The standard link is monitored continuously in Box 410. As long as the standard link remains inoperative, the SS7 link stays connected over the LEO backup link (Box 412), and the wireline link is monitored. If the standard link is found to be operative, the LEO backup link is disconnected (Box 414), and information exchange is resumed over the standard link.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices may likewise be constructed to implement the methods described herein. Furthermore, alternative software implementations including, but not limited to, distributed processing or component/object distributed processing, parallel processing, or virtual machine processing may also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method of providing a telecommunication link, comprising:
transferring data over a standard communication link between a first and a second telecommunication device in a telecommunication network; and
establishing a communication link over a satellite to transfer the data between the first and second telecommunication devices when the data transfer over the standard communication link is impaired.

2. The method of claim 1, wherein establishing the communication link over a satellite further comprises establishing a communication link over a Low Earth Orbiting (LEO) satellite.

3. The method of claim 1, wherein transferring data over the standard telecommunication link further comprises utilizing a Signaling System 7 protocol.

4. The method of claim 1, wherein the first device is a Service Switching Point (SSP) and the second device is a Signal Transfer Point (STP).

5. The method of claim 1, wherein transferring data over the standard communication link further comprises transferring data over one of (i) a hardwire, and (ii) an optical link.

6. The method of claim 1, wherein establishing the communication link over a satellite further comprises:
detecting an impairment of in the standard communication link; and
automatically establishing the communication link over a satellite in response to detecting the impairment of the standard communication link.

7. The method of claim 1, wherein establishing the communication link over a satellite further comprises converting signals provided by the first telecommunication device in a first format to signals in a second format for transmission to the satellite.

8. The method of claim 1, wherein establishing the communication link over a satellite further comprises splitting the data over multiple channels.

9. A telecommunication system, comprising:
a standard communication link for transferring data between a first and a second telecommunication device in a telecommunication network; and
a communication link over a satellite established for transferring the data between the first and second telecommunication devices when the data transfer over the standard communication link is impaired.

10. The system of claim 9, wherein the communication link over a satellite further comprises a communication link over a LEO satellite.

11. The system of claim 9, further comprising transferring data between the first and second devices over the standard communication link utilizing a Signaling System 7 protocol.

12. The system of claim 9, wherein the first device is a Service Switching Point (SSP) and the second device is a Signal Transfer Point (STP).

13. The system of claim 9, wherein the standard link further comprises one of (i) a hardwire, and (ii) an optical link.

14. The system of claim 9, wherein establishing the communication link over a satellite further comprises:
detecting an impairment of the standard communication link; and
establishing the communication link over a satellite in response to detecting the impairment of the standard communication link.

15. The system of claim 9, wherein establishing the communication link over a satellite further comprises converting signals provided by the first telecommunication device in a first format to signals in a second format for transmission over the satellite.

16. The system of claim 9, wherein establishing the communication link over a satellite further comprises splitting the data over multiple channels.

17. An apparatus for establishing a telecommunication link, comprising
a first device that receives data relating to a telecommunication service and converts the received data into a first format for transmission over a physical communication link;
a second device coupled to the first device, via the physical telecommunication link and a satellite; and
a third device that converts the data from the first format to a second format and transmits the data in the second format to the satellite for further transmission to the second device when the standard communication link is impaired.

18. The apparatus of claim 17 wherein the first device is an SSP device and the second device is an STP device and the first format is in an SS7 protocol.

19. The apparatus of claim 17 wherein the third device automatically transmits data to the satellite upon detection of an impairment of the physical telecommunication link and discontinues data transmission to the satellite when the physical link is no longer impaired.

20. The apparatus of claim 17 wherein the third device splits the data from the first device over multiple channels for transmission to a lower earth orbit satellite.
